(19) United States
(12) Patent Application Publication
(10) Pub. No.: US 2011/0073235 A1
(43) Pub. Date: Mar. 31, 2011

(54) Process For Making Flexographic Plates

(76) Inventor: Jeffrey E. Sunnergren, College Park, GA (US)

(21) Appl. No.: 12/777,332

(22) Filed: May 11, 2010

Related U.S. Application Data
(60) Provisional application No. 61/245,879, filed on Sep. 25, 2009.

(51) Int. Cl. B32B 37/02

(52) U.S. Cl. 156/60

(57) ABSTRACT

A method for making a flexographic plate having a photopolymer layer by applying a coating layer having a thickness of between a molecule and 0.0005 of an inch to the surface of an unexposed photopolymer material where the coating layer wets the surface of the unexposed photopolymer layer. After the coating layer is dried, a negative image film is laminated to the coating layer on the unexposed photopolymer material.

### REFERENCE TO RELATED APPLICATIONS

This patent application claims the benefit of U.S. Provisional Application No. 61/245,879 filed on Sep. 25, 2009, the disclosure of which is incorporated herein by reference in its entirety.

### BACKGROUND OF THE INVENTION

1. Field of the Invention

The present invention relates generally to a flexographic plate and more specifically to a method of making flexographic plates having a photopolymer surface for producing clear, crisp print images.

2. Description of Related Art

Flexographic printing plates are well known for use in letterpress printing, particularly on surfaces that are soft and easily deformable, such as cardboard, wrapping paper and plastic films.

A prior art flexographic plate normally consists of a back sheet which is a plastic film about 5 mils or so thick; an unexposed photopolymer layer; a protective slip film; and a cover sheet. The back sheet provides required support to the plate. The slip film is a thin sheet of between a molecule and 0.0005 of an inch thick and is transparent to UV light. A protective cover sheet is located on top of the slip sheet.

In use, the cover sheet is removed and is replaced with a negative of a film, and UV light is shined on the film to chemically change the areas of the photopolymer layer that are exposed to the UV light. During the washout process, only the exposed areas remain.

When the photopolymer layer is exposed to UV light, the transparent slip film, which is a mesh material, keeps the film away from the photopolymer allowing shadows and partial chemical reactions which adversely affect the sharpness of the image that can be produced by the photopolymer layer.

Therefore, because there is a slip layer, Analog plates which use a film can not accurately reproduce images above 133 line screen. These images tend to lose detail with reverse color fill and oversized rounded dots. Methods for making flexographic printing plates are disclosed, for example, in the following:

### U.S. PreGrant Pub. No. 2009/0000735A1

### Inventor: Zwadlo; et al.

### Published: Jan. 1, 2009

Discloses laminating a masking film onto a pre-press flexographic printing plate to place the plate in optical contact with the film by applying a balanced, non-distorting force to the flexographic printing plate and masking film. This method includes laminating the pre-press flexographic printing plate with the film mask by applying an optimized lamination force to achieve optical contact while minimizing lateral film distortion.

### U.S. Pat. No. 7,279,254

### Inventor: Zwadlo

### Issued: Oct. 9, 2007

Relates to making an article bearing a relief image using a removable film. First, an imagable film that contains at least a mask substrate and an imagable material is imagewise exposed to imaging radiation to form an imaged film. The imaged film is then transferred to an imagable article, such as a flexographic printing plate precursor. The resulting assembly is exposed to curing radiation resulting in exposed and unexposed areas of photosensitive material on the imagable article. Following exposure to curing radiation, the imaged film is then removed from the imagable article. The imagable article is then developed with a suitable developer to form a relief image. The imaged film may then be reused to make additional articles bearing the relief image.

### U.S. Pat. No. 7,338,749

### Inventor: Kunita

### Issued: Mar. 4, 2008

Discloses making a flexographic printing plate by forming an image mask on a flexographic printing starting plate by discharging an oil-based ink by an ink-jet method where the flexographic printing starting plate has a support and a photosensitive resin layer provided thereon. The photosensitive resin layer is then subjected to overall exposure via the image mask; and the photosensitive resin layer thus exposed is developed.

### U.S. PreGrant Pub. No. 20060249239A1

### Inventor: Krauss; Uwe; et al.

### Published: Nov. 9, 2006

Photopolymerizable cylindrical, continuously seamless flexographic printing elements are produced by applying a layer of a photopolymerizable material to the outer surface of a hollow cylinder and joining the edges by calendering. Flexographic printing elements produced in this manner are used for the production of flexographic printing plates.

### U.S. Pat. No. 6,844,142

### Inventor: Schadebrodt, et al.

### Issued: Jan. 18, 2005

Flexographic printing plates are produced by thermal development by a process in which an image wise exposed flexographic printing element is developed by heating and removing softened, unpolymerized parts of the relief-forming layer, the flexographic printing element used has an olefin/(meth)acrylate copolymer with an olefin content of from 50 to 94 mol %. The photopolymerizable flexographic printing element comprises an olefin/(meth)acrylate copolymer having a content of from 50 to 94 mol % of olefin monomers, from 6 to 50 mol of (meth)acrylate monomers and from 0 to 5 mol % of further comonomers. This flexographic printing element is used for the production of flexographic printing plates both by thermal development and by development by means of washout compositions.

### U.S. Pat. No. 6,773,859

### Inventor: Fan, et al.

### Issued: Aug. 10, 2004

Discloses a process for preparing a flexographic printing plate from a photosensitive element having a photopolymerizable layer and a thermally removable layer on the photopolymerizable layer. The process includes imagewise exposing the photosensitive element and thermally treating the exposed element to form a relief suitable for use in flexographic printing. The thermally removable layer can be transparent or opaque to actinic radiation. The invention also relates to a photosensitive element for use in this process. The photosensitive element includes a photopolymerizable layer and at least one thermally removable layer having a filler and a binder, wherein the binder is less than 49% by weight, based on the total weight of the binder and filler.

### U.S. Pat. No. 5,994,026

### Inventor: DeBoer, et al.

### Issued: Nov. 30, 1999

Discloses a flexographic imaging element having a relief imaging layer and a multi-level writeable mask layer on a support. The mask layer is capable of multi-level communication with the underlying relief imaging layer so that the resulting image has continuous tone densities corresponding to the information written on the mask layer.

### U.S. Pat. No. 5,888,701

### Inventor: Fan

### Issued: Mar. 30, 1999

Discloses a photosensitive printing element having an overall layer of powder material and a process for making a flexographic printing plate from such an element are disclosed. The photosensitive element includes a support, a photopolymerizable layer, and a layer of powder material on the photopolymerizable layer. The layer of powder material can be opaque or transparent depending upon desired use.

### U.S. Pat. No. 5,925,500

### Inventor: Yang, et al.

### Issued: Jul. 20, 1999

Discloses a method of making Laser-imagable flexographic printing plates. A thin polymeric film doped with a UV absorber is laminated to a photopolymer layer. The film is ablated from the photopolymer using a laser operating at a selected wavelength to create an in situ negative. The resulting negative can be subjected to typical UV flood exposure and development.

### U.S. Pat. No. 5,460,920

### Inventor: Telser, et al.

### Issued: Oct. 24, 1995

Flexible printing plates are produced from printing plates consisting essentially of a dimensionally stable substrate and a recording layer by a process in which the printing plate is produced alternatively either by photochemical or by mechanical structuring, and in the case of photochemical structuring the photosensitive recording layer is exposed image wise and the unexposed parts of the recording layer are washed out with a developer and in the case of mechanical structuring the originally photosensitive, uniformly exposed recording layer is cut image wise and the nonprinting parts of the recording layer are peeled off from the substrate.

The printing plates produced by this process are suitable for the production of products printed by the flexographic method and for lacquering products printed by the offset method.

### U.S. Pat. No. 5,462,863

### Inventor: Hornschuh

### Issued: Oct. 31, 1995

Discloses a method of manufacturing a flexographic printing plate having a base (polyester foil) and a soft caoutchouc mass which is enriched with photo-initiators (photo-polymer) and is arranged on the base, wherein a film with the image to be printed is fastened with precise fit on a free surface portion of the caoutchouc mass. The method includes removing the caoutchouc mass at the edges of the base intended for fastening. The base is provided with register holes in the areas of the exposed edges of the base and the base is placed with the register holes on register pins of an assembly rail. Spacer pieces are placed on the exposed edges of the base, wherein the thickness of the spacer pieces corresponds to the thickness of the removed caoutchouc mass. A film having corresponding register holes is placed on the register pins. Finally, exposure to light, washing and assembly in the printing machine are carried out.

### U.S. Pat. No. 5,552,262

### Inventor: Konermann

### Issued: Sep. 3, 1996

Relates to high volume manufacturing process for flexographic printing plates comprises wash out, drying and post-exposure. During drying the printing plates are transported with a plurality of endless conveyors. The transport speed during drying/post-exposure is lower than the transport speed during wash out such that a storage of flexographic plates can be achieved in the drying and post exposure portion of the process.

### U.S. Pat. No. 5,240,815

### Inventor: Telser, et al.

### Issued: Aug. 31, 1993

Discloses a process for the production of a flexographic relief printing plate from a photosensitive recording element which contains

A) a dimensionally stable substrate and
B) at least one photopolymerizable recording layer having
b.sub.1) at least one elastomeric polymer as a binder,
b.sub.2) at least one photopolymerizable monomer which is compatible with the binder (b.sub.1) and
b.sub.3) at least one photopolymerizable initiator, by imagewise exposure of the photopolymerizable recording layer (B) to actinic light and
washout (development) of the unexposed and therefore nonphotopolymerized parts of the imagewise exposed recording layer (B) with an organic developer with formation of a relief layer,
wherein the organic developer contains from 1 pphm (1 part per 100,000,000) to 3% by weight, based on its total amount, of at least one antistatic agent.

### U.S. Pat. No. 5,112,725

### Inventor: Kurtz, et al.

### Issued: May 12, 1992

Discloses a flexographic printing plate which is resistant to ozone cracking and where the flexible recording layer has an anisotropy factor AF of <1.5 is produced from a photosensitive mixture consisting of

A) one or more elastomeric binders,
B) a mixture of B1) from 5 to 20% by weight of one or more photopolymerizable organic compounds which are compatible with (A) and contain two or more olefinic double bonds and
B2) from 1 to 15% by weight of one or more monoolefinically unsaturated organic compounds which are compatible with (A) and whose homopolymer has a glass transition temperature which is below room temperature,
C) from 0.1 to 10% by weight of one or more photoinitiators and
D) from 0 to 27% by weight of conventional assistants and additives, the anisotropy factor AF of the flexible recording layer being defined as the ratio of the moduli of elasticity at 100% elongation of strips measuring 2 times 15 cm which have been punched from the flexible recording layer during production of the raw plate, on the one hand along the flow direction of the photosensitive mixture used and on the other hand crosswise to the said direction and have then been exposed uniformly.

### U.S. Pat. No. 5,175,072

### Inventor: Martens

### Issued: Dec. 29, 1992

Negative-acting photohardenable compositions are useful in flexographic printing plate manufacture without the use of solvent development. Unhardened composition is softened and absorbed by an absorbent sheet. Absorbed composition can be removed from the sheet and recycled.

### U.S. Pat. No. 5,015,556

### Inventor: Martens

### Issued: May 14, 1991

Negative-acting flexographic printing plates display enhanced performance when backside irradiated with ionizing radiation instead of longer wavelength ultraviolet radiation. A better defined floor and more readily controlled floor is produced on the final printing plate.

### U.S. Pat. No. 4,917,990

### Inventor: Herrmann

### Issued: Apr. 17, 1990

A photosensitive printing plate for use in flexographic printing is disclosed, which has a transparent, flexible, dimensionally stable plastic film support, an adhesive layer comprising a chlorosulfonated polyethylene, and a light-hardenable layer comprising an elastomer. In the plate, adhesion of the light-hardenable layer to the support is improved. Additionally a process for the production of said printing plate is disclosed by: coating a transparent, flexible, dimensionally stable plastic film with an adhesive layer comprising a chlorosulfonated polyethylene; applying a light-hardenable layer having an elastomer to the adhesive layer; and exposing the light-hardenable layer through the plastic film without using an original such that a thin, light-hardened lower stratum is formed on that side of the light-hardenable layer which is in contact with the adhesive layer.

### SUMMARY OF THE INVENTION

In an exemplary embodiment of the present invention, there is disclosed a method for making a flexographic plate having a photopolymer layer by applying a coating layer having a thickness of between a molecule and 0.001 of an inch to the surface of an unexposed photopolymer material where the coating layer wets the surface of the unexposed photopolymer layer. After the coating layer is dried, a negative image film is laminated to the coating layer on the unexposed photopolymer material.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 shows an embodiment of a prior art analog plate;

FIG. 2 shows the prior art analog plate of FIG. 1 with cover sheet and slip film removed;

FIG. 3 shows a fine mist being sprayed onto analog plate of FIG. 2 to coat the analog plate with a coating having a thickness that is less than 0.001 of an inches in accordance with the principles of the invention;

FIG. 4 shows the coated analog plate of FIG. 3 while the coating is drying in accordance with the principles of the invention;

FIG. 5 shows a masking film being laminated onto the dried coating on the analog plate of FIG. 4 in accordance with the principles of the invention; and

FIG. 6 is a flow diagram of a method of making a flexographic plate in accordance with the principles of the invention.

### DESCRIPTION OF THE PREFERRED EMBODIMENT

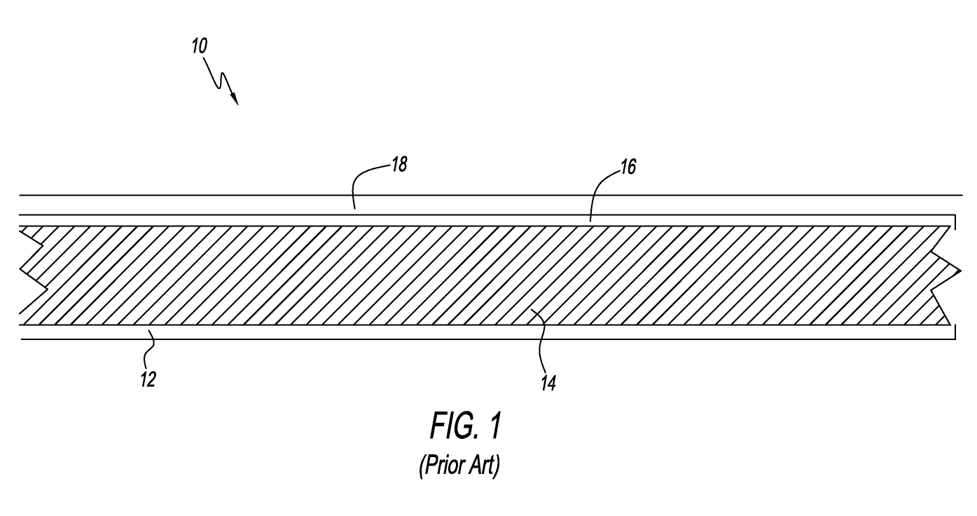

Referring to FIG. 1, there is disclosed an embodiment of a prior art analog plate 10. Analog plate 10 has a base or back sheet 12 of Bi-axially-oriented polyethylene terephthalate material such as Mylar® upon which is placed a layer 14 of a highly controlled mixture of photopolymer which is unexposed and has a specific thickness. On top of the photopolymer layer 14 of the mixture of photopolymer is a nylon membrane mesh material 16 having a thickness of about 0.002 inches. This nylon membrane mesh material is referred as a slip film. The purpose of the slip film is to allow a suction to remove air from between the photopolymer layer and a film sheet 18, which is the negative image film, as film sheet 18 is applied to the top surface of the nylon mesh material 16. Thus, the film sheet 18 is separated from the photopolymer layer by the thickness of the slip film 16.

When making a flexographic plate containing a photopolymer surface, the UV exposure light that passes through the image film 18 is refracted and some of this refracted light that is under the negative film 18 is bent. The UV light, which starts a chemical reaction when it impinges on the photopolymer material, only affects areas of the photopolymer material that is located under transparent areas of the negative film to provide images having fine details and sharp edges. However, because the slip film separates the surface of the photopolymer material 14 from the film sheet 18 by about 0.002 of an inch, shadows and/or semi lighted areas occur on the surface of the photopolymer material which causes loss of detail and surfaces having rounded edges.

Prior art technology using films and slip film do not produce a fine detailed image. The images produce can have large dot gain which results in loss of detail. It is desirable to eliminate the slip film to improve the detail and sharpness of images that are produced.

The flexographic plate of the present invention can be used to produce fine detailed images having sharp well defined edges. In the present invention a very thin layer that is less than 0.001 of an inch thick replaces the slip film. The very thin layer here disclosed has a thickness that is between a molecule to 0.001 of an inch. This very thin layer is applied to the photopolymer layer by spraying, evaporation or the like.

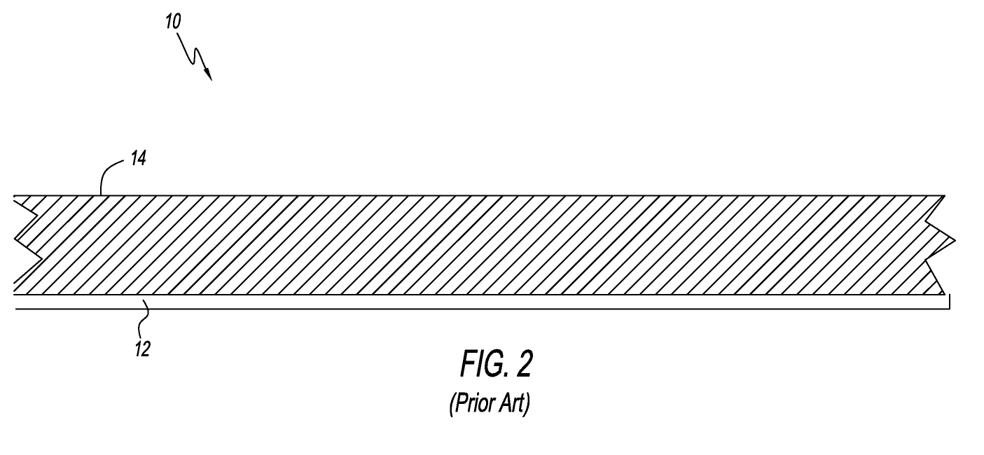

Referring to FIG. 2, there is shown the prior art analog plate of FIG. 1 with cover sheet and slip film removed. Analog plates using negative film typically have a slip film of a nylon membrane mesh material having a thickness of about 0.002 of an inch attached to the top of the photopolymer material. If a prior art plate is to be modified in accordance with the principles of this invention, the nylon membrane mesh material must be removed before the plate can be used. This mesh material can be removed mechanically with an adhesive such as packing tape or chemically by soaking the plate in N-Butyl Alcohol.

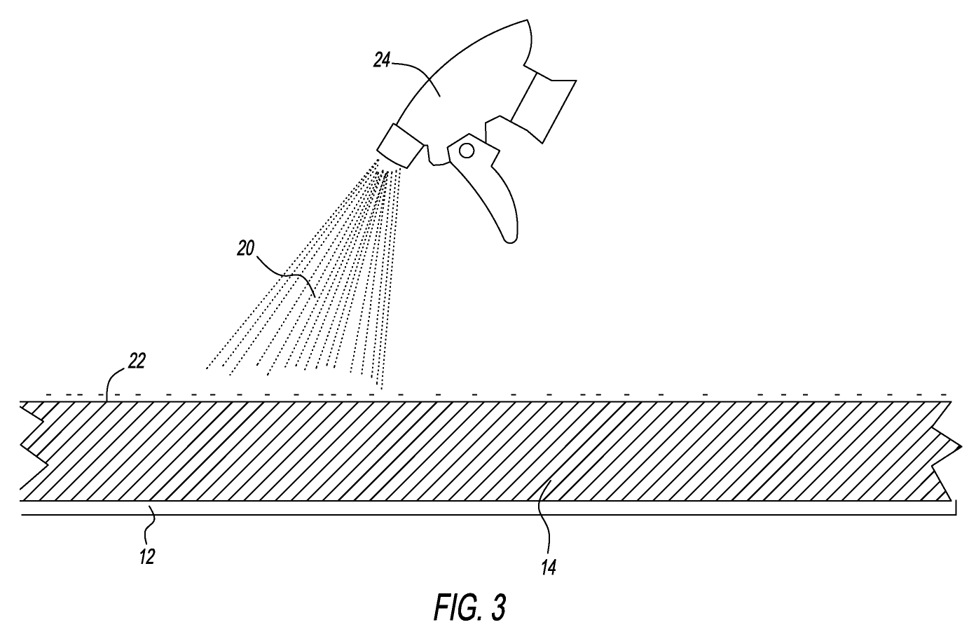

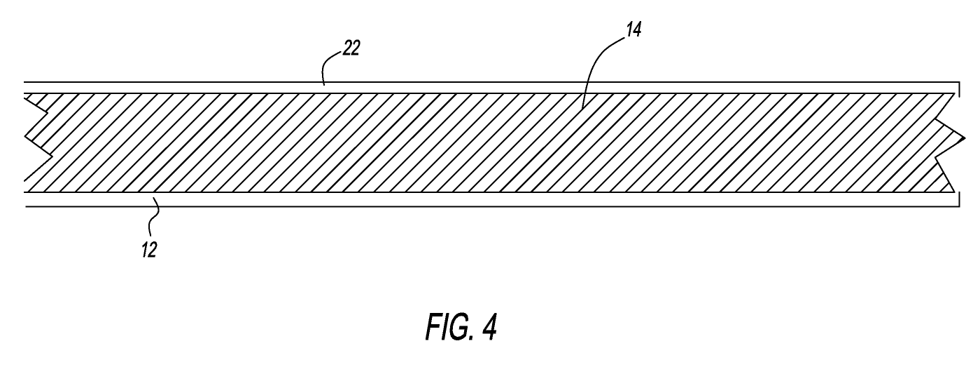

Referring to FIG. 3, there is shown a fine mist 20 being sprayed by a spray system 24 onto the photopolymer layer 14 to coat the surface of the photopolymer material 14 with a film coating 22 having a thickness that is less than 0.001 of an inch. The very thin layer of film coating 22 can be applied by spraying or evaporating (not shown) a chemical that will allow the film to wet the surface of the photopolymer material without reducing the translucency of light that passes through the film coating 22. The chemical used may be a water based silicon, a water wax, a hydrocarbon or an adhesive such as Dow Chemical® HV-490, Dow Chemical® HV-495 or ChemTrend® Pura 17080W. The film coating is then dried thoroughly to remove all traces of water, see FIG. 4. Wet film coating can be dried by using a heat gun (not shown), a heat lamp (not shown) or by placing the assembly into an oven (not shown) that is set at a temperature of about 140 degrees F. more or less.

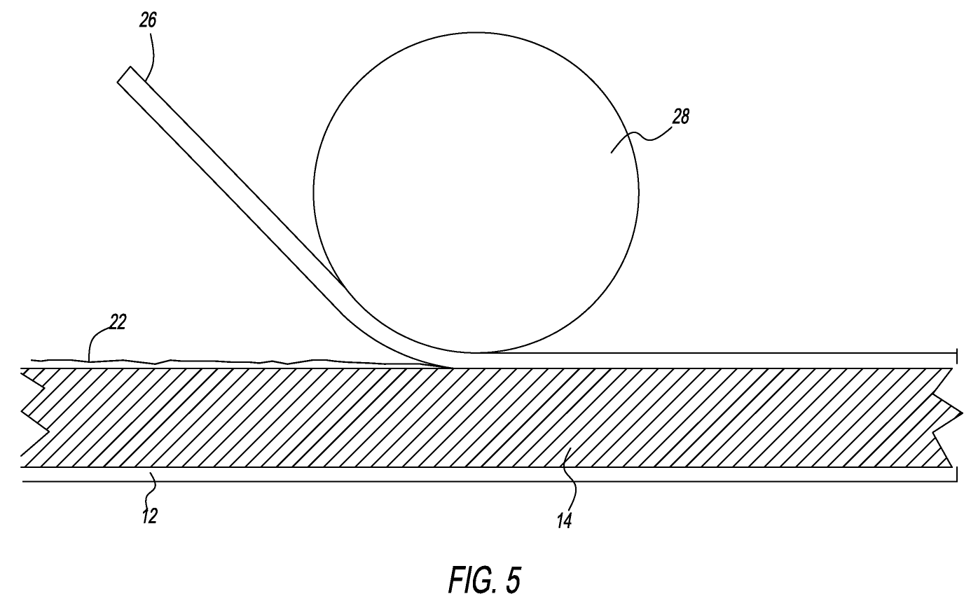

A negative film 26 is then laminated to the film coating in such a manner that all air is purged from between the negative film and the molecular film coating 22, see FIG. 5. This may be accomplished by using a laminating roller 28 having a durometer hardness of about 50. Once the negative film is laminated to the film coating 22, it is moved to a standard photopolymer exposure unit.

The absence of the slip film of a nylon membrane mesh material having a thickness of about 0.002 inches on the top of the photopolymer material allows the negative image film to rest directly on the photopolymer. While refraction still occurs, the light is refracted directly into the film coating and the photopolymer material. With this invention the light density on the surface of the photopolymer material is equal for both large and small features which allows for an image having finer features to be produced.

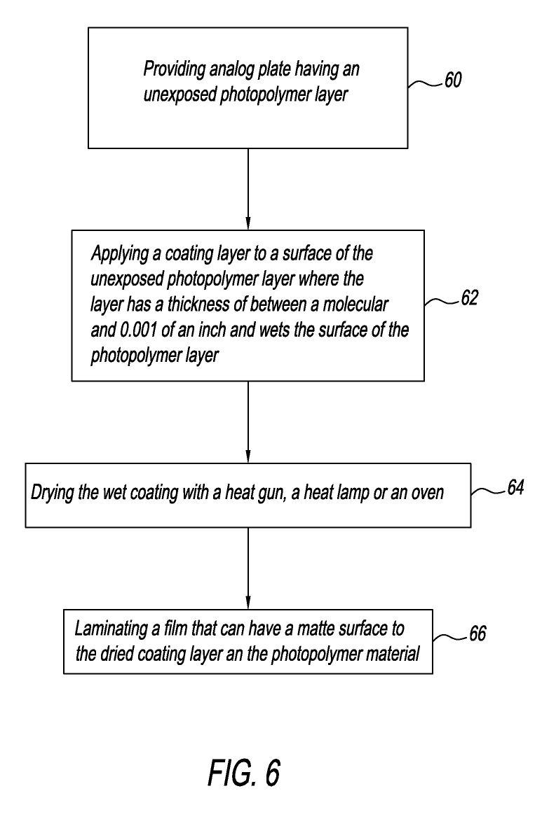

Referring to FIG. 6, there is shown a flow diagram of a method of making a flexographic plate in accordance with the principles of the invention. At the first step an analog plate having an unexposed photopolymer layer is provided, block 60. Then, a coating layer is applied to a surface of the unexposed photopolymer layer where the layer has a thickness of between a molecular and 0.0005 of an inch and wets the surface of the photopolymer material, block 62. Thereafter, the coating layer is dried using a heat gun, a heat lamp or an oven, block 64. After the coating layer is dried, a negative film that can have a matte surface is laminated to the dried coating layer, block 66.

Because the image film used is silver halite or a laser ablative ink film, the shape of the features in the image film can be made very fine to allow sharp images to be photoengraved into the photopolymer material. The very thin layer which has a thickness that is between a molecule to 0.0005 of an inch which is placed on the photopolymer material limits the amount of refraction that can occur. The very thin layer allows the photopolymer plate material to thermally move as it increases in temperature without separating. The negative image film that is laminated to the very thin coating layer and the photopolymer material having a matte surface will cause the surface of the photopolymer to become rough which allows for better ink transfer. The plate is imaged in an exposure unit in the traditional way. Once the plate has been exposed, the imaged film is removed and the plate is ready for use.

Because Oxygen inhibits photo polymerization, the film acts as a barrier and allows complete polymerization. This means that dots don't shrink because of lack of polymerization and no bump curves are required in the highlight (small dots 3-10%) areas. Predicative results include 1% dots transfer 1% ink, 2% dots transfer 2% ink, 50% dots transfer 50% ink etc.

All screens and solid areas begin to print at the same time which provides better dot formation because the film coating is molecular as compared with carbon masks which use carbon grains that generate course dots. The film allows optimal use of photo polymer plate material as the film is moved around to use as much material as possible thus keeping scrap to a minimal. This process does not need a vacuum to hold the film on to the plate. Therefore a kreen sheet is not necessary.

Negatives are reusable and old negatives can produce better results than the conventional method as compared to this method. Since the laser only exposes the film, laser control is not as critical as LAMS plates with the carbon mask and plate being exposed together

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A method for making a flexographic plate having a photopolymer layer comprising:
applying a coating layer to a surface of said photopolymer layer that is unexposed and which wets the surface of said unexposed photopolymer layer;
drying said coating layer; and
laminating a film to said dry coating layer.

2. The method of claim 1 wherein said coating layer is sprayed onto the surface of said photopolymer layer.

3. The method of claim 1 wherein said coating layer is evaporated onto said photopolymer layer.

4. The method of claim 2 wherein said coating layer is sprayed onto the surface of said photopolymer layer as a fine mist.

5. The method of claim 2 wherein said coating layer is evaporated onto the surface of said photopolymer layer.

6. The method of claim 2 wherein said coating layer has a thickness of less than 0.0005 of an inch.

7. The method of claim 2 wherein said coating layer has a thickness of between a molecule and 0.0005 of an inch.

8. The method of claim 2 wherein said coating layer has a thickness of a molecule.

9. The method of claim 7 wherein translucency of light through said coating layer to said photopolymer layer is not noticeably reduced.

10. The method of claim 7 wherein said coating layer is a water wax.

11. The method of claim 7 wherein said coating layer is a hydrocarbon.

12. The method of claim 7 wherein said coating layer is an adhesive.

13. The method of claim 1 wherein drying of said coating layer is with a heat gun.

14. The method of claim 1 wherein drying of said coating layer is in an oven.

15. The method of claim 14 wherein drying of said coating layer is a temperature of 140 degrees F.

16. The method of claim 1 wherein the film is laminated to the film with a roller.

17. The method of claim 16 wherein said roller has a durometer hardness of 50 more or less.

18. The method of claim 17 wherein said film laminated to the dry coating layer has a matte surface.
